(19) United States
(12) Patent Application Publication
(10) Pub. No.: US 2017/0164647 A1
(43) Pub. Date: Jun. 15, 2017

(54) Method for Brining Nuts

(71) Applicant: Diamond Foods, Inc., Stockton, CA (US)

(72) Inventors: Marianne Paloncy, Salem, OR (US); Michael Platt, Tualatin, OR (US); Carolyn Ottenheimer, Albany, OR (US); Bruce Bechtel, Corvalis, OR (US)

(21) Appl. No.: 14/966,354

(22) Filed: Dec. 11, 2015

(51) Int. Cl. A23L 1/36

(52) U.S. Cl. CPC A23L 25/00; A23L 5/12; A23L 5/19; A23V 2002/00

(57) ABSTRACT

The disclosed method describes a process for creating brined peanuts that have improved crunch and flavor characteristics compared with conventional peanuts. The nuts are soaked in a brine solution comprising at least 10% salt by weight and water for 6-16 hours. In some embodiments, the brine solution includes other heat tolerant flavors, such as cayenne pepper, hot sauce and capsicum extract. The nuts are drained for at least one hour to a moisture level of 21-24% water by weight. The nuts are then oil roasted at 305° F. for 11 minutes via a technique that fully enrobes the nuts in hot oil, such as a full submersion fry.

### BACKGROUND

Field of Art

The disclosure generally relates to the field of soaking and roasting nuts, particularly brining and oil roasting peanuts.

Description of the Related Art

Nuts, including both tree nuts and legumes, are processed in a variety of ways in order to introduce or enhance flavoring and texture. In particular, peanuts are conventionally made crunchy via blistering techniques. Blistering involves boiling peanuts in water and then oil roasting them. Blistered peanuts then have any desired flavoring (i.e., seasoning) added after both the boiling and oil roasting steps have taken place. Because the flavoring is added on top of the nut, the final product can be messy and leave the flavoring on other surfaces the nut comes into contact with (i.e., fingers). Additionally, using boiling water can be a safety hazard during processing.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a flowchart illustrating a general method for brining peanuts, according to one embodiment.

FIG. 2 is a flowchart illustrating a method for producing salty brined Virginia peanuts, according to one embodiment.

### DETAILED DESCRIPTION

The Figures (FIGS.) and the following description relate to preferred embodiments by way of illustration only. It should be noted that from the following discussion, alternative embodiments of methods disclosed herein will be readily recognized as viable alternatives that may be employed without departing from the principles of what is claimed.

### Overview

The disclosed method creates a more desirable product and overcomes the limitations of present methods by brining nuts. The method is particularly useful, though not limited, to nuts that can absorb a significant amount of liquid, like peanuts. The method will be described throughout with respect to peanuts, though it should be understood that the method can be applied to any nut with similar properties.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### General Method for Brining Peanuts

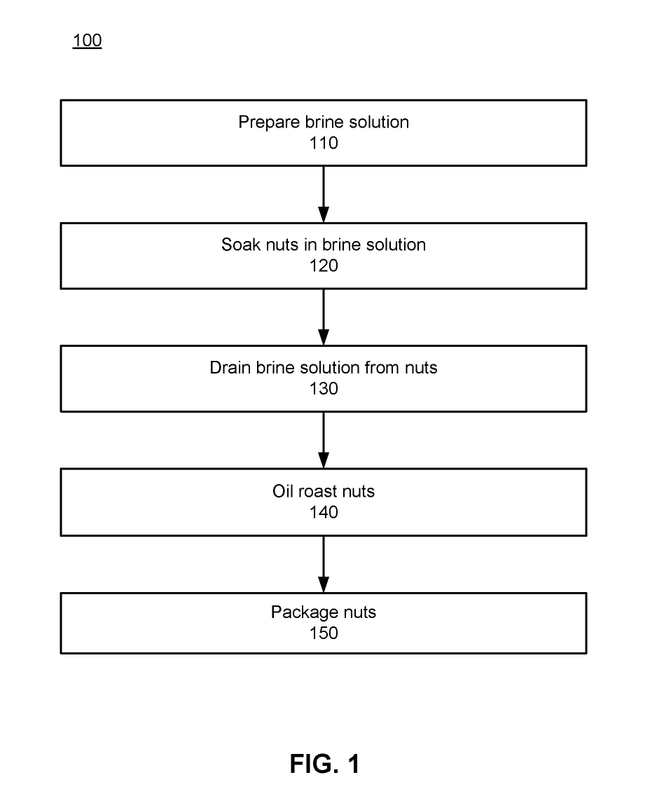

FIG. 1 is a flowchart illustrating a general method for brining peanuts, according to one embodiment. Though the processing time is longer than conventional blistered peanuts, the result of this method is an edible peanut snack that differs from those currently available because it has a crunchier texture and the flavor is distributed throughout the nut (compared to just on the surface of the nut). Thus, for example, the flavor will not come off the nut during handling and before consumption.

To create this peanut product, a brine solution is prepared 110 such that it contains the desired flavor(s) in a water solution. At a minimum, the brine solution contains water and salt. It is preferable that the brine solution contain at least 10% salt by weight because of potential antimicrobial properties exhibited at 10% salt solutions and above. Additionally, brine solutions containing less than 9.5% salt by weight in practice do not produce as crunchy of a final product. Furthermore, 26% salt by weight is the observed saturation point of salt in water at ambient temperature, creating an upper bound on salt concentration of tested brine solutions. Based on flavor and texture testing, brine solutions with 10%-15% salt by weight is found to produce the most desirable characteristics. Additionally, the more salt the brine solution contains, the more quickly the peanuts absorb sodium, which can lead to a finished peanut product with sodium levels that exceed desired nutritional guidelines. Thus, brine solutions with 10% salt content by weight are found to result in the overall best finished nut product based on flavor and nutritional metrics.

In some embodiments, the brine solution includes additional flavors, depending on the desired flavor characteristics of the finished peanut product. It is preferable that the additional flavors be heat tolerant, particularly to survive the oil roasting 140 step. Examples of heat tolerant flavors that could be used include smoke, onion, garlic, citrus, chili, spice (e.g., cinnamon, cumin, paprika, curry, pepper), extracts (oil of herbs, spice extracts), and Asian flavors (soy, sesame, ginger).

Peanuts are soaked 120 in the brine solution to absorb the flavors contained in the brine solution. In contrast to conventional boiling of peanuts, the brine solution is prepared with ambient water (58-72° F. depending on the time of year) and kept at ambient temperature for the duration of the soaking. Using ambient water instead of hot water removes a safety hazard from application of the method during processing. Because peanuts are legumes, they are able to absorb significant amounts of liquid (i.e., the brine solution). By absorbing the brine solution, the flavors in the brine solution are increasingly absorbed into the body of the peanut, resulting in a product that have flavor distributed within the peanut rather than concentrated on the surface. For the most even flavor throughout the peanut, it is desirable for the soak period to be long enough to allow the flavors to be absorbed into the peanut. The length of the soak period also affects the texture of the finished peanut product. Too short of a soak period does not result in enough crunch, while too long of a soak time results in toughness in addition to crunch. The soaking period can depend on a variety of factors such as brine composition, desired flavor, and peanut variant, and in various embodiments are optimized to have the best flavor and texture.

In testing two different variants of peanut with brine solutions of 10-15% salt by weight, it has been found that they have different optimal soak times. For Jumbo Runner peanuts, a soak time of 12-16 hours has been determined to result in the preferred flavor and texture characteristics. For Virginia peanuts, a soak time of 5-7 hours has been determined to result in the preferred flavor and texture characteristics. Based on soak period testing, it has been determined that the moisture level (amount of water contained in the nut by weight) of peanuts after 6 hours of soaking is 25-27%, while the moisture level after 12-16 hours of soaking is about 35%. For contrast, raw peanuts have a moisture level of 5-6%.

In order for peanuts to absorb the brine solution evenly, the peanuts stay completely submerged in the brine solution for the duration of the soak period. Both vessel shape and ratio of brine solution to peanuts can affect the extent to which the peanuts are submerged. The shape of the vessel can alter how much brine solution is required to keep the peanuts submerged throughout the soaking period. In particular, it has been found that a square bin, such as a hopper bin (manufactured by SmaK Plastics, Inc., 9116 NE 130th Ave., Ste. 106, Vancouver, Wash., 98682), allows for an even distribution of peanuts and brine solution, and provides room for the peanuts to expand while remaining submerged. Additionally, testing has shown that a brine solution of at least 50% (by weight) is needed for the peanuts stay fully submerged in the brine solution for the duration of the soak period. Thus, in one embodiment, a 50-50 ratio of brine solution to peanuts is found to be optimal because uses the least amount of brine solution per peanut, but a 60-40 ratio of brine solution to peanuts is also found to produce good results.

In one embodiment, the soaking 120 step takes place in a partial vacuum (e.g., an environment that is maintained at less than atmospheric pressure, such as a vacuum tunnel or a vacuum tumbler). Lowering the pressure of the peanut and brine solution mixture forces the peanuts to both absorb the brine solution more quickly and absorb more brine solution overall. Thus, performing the soaking 120 step could increase the flavor intensity of the finished peanut product and reduce the duration of the soaking period. Testing indicates that a soak period of 1-3 hours, preferably 1-2 hours, may produce similar flavor and texture results to the longer soak periods described above that are performed at atmospheric pressure. Additionally, absorption of more brine solution overall could decrease the required brine solution concentration. That is, fewer flavoring ingredients would be needed to produce the same flavor, reducing the cost of the soaking 120 step. In some embodiments, performing the soaking 120 step in a partial vacuum results in higher moisture levels than those described above with respect to atmospheric pressure, and thus the draining 130 and/or oil roasting 140 steps described below are modified to remove the extra moisture.

Once the soaking 120 is complete, the brine solution is drained 130 from the nuts to dry the nuts slightly and remove residual moisture from the processing bins. Peanuts that are too moist process less efficiently. For example, in such instance more moisture is transferred to the oil roaster, which both increases the oil roasting processing times and degrades the oil more quickly. Additionally, moist peanuts do not move well along vibrating conveyor belts used for processing and are susceptible to clumping up. The peanuts can be drained 130, for example, by gravity, centrifuge assisted draining, or other suitable mechanisms. In addition to removing excess liquid before oil roasting 140, the draining period also allows surface moisture to penetrate further into the body of the peanut. It has been discovered that the peanuts should be moved to the next processing step within 6 hours of being drained 130 to prevent excessive breakdown and softness of the nuts, as well as spoiling.

The majority of the remaining water absorbed by the nuts in the soaking step 120 is driven out via oil roasting 140. Conventional oil roasted peanuts are processed at 295-300° F. for 6-8 minutes. However, due to the increased moisture level of the drained brined peanuts (21-24% compared to 3.5-5.2% in conventional peanuts), oil roasting 140 takes place at higher temperatures for longer times in order to purge the water absorbed during soaking 120. Preferably, brined peanuts are oil roasted at 305° F. for 11 minutes to produce a finished product that is crunchy instead of chewy. Though techniques that do not fully enrobe the peanuts in hot oil, such as a curtain fry (which is more efficient and uses less oil), are acceptable for conventional peanuts, it is preferred that brined peanuts be fully enrobed in hot oil, such as in a full submersion fry, in order to thoroughly purge the excess water and produce a crunchy finished product. After being oil roasted 140, the peanuts will preferably have a moisture level below 2%.

Finally, the peanuts are cooled and packaged 150. Due to concerns about increased staling of brined peanuts, processed peanuts are packaged 150 and gas flushed within 7 days to minimize or prevent oxidative reactions. It is preferable that, before packaging, the peanuts are also stored in conditions where oxidative reactions are controlled, such as under refrigeration or at a temperature of approximately 70° F.

### Example Method for Salty Brined Peanuts

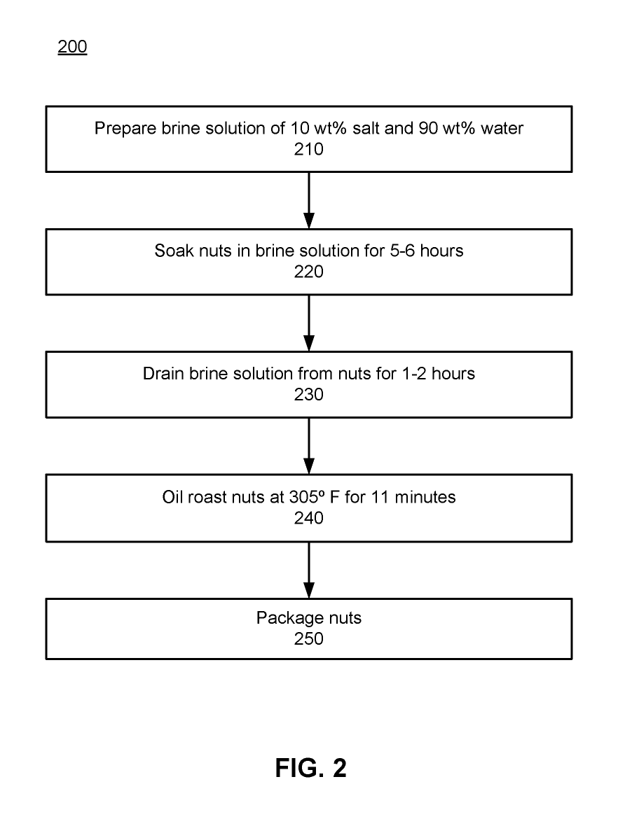

FIG. 2 is a flowchart illustrating a specific peanut brining method for producing salty brined Virginia peanuts, according to one embodiment. A brine solution comprising 10% salt and 90% water (by weight) is prepared 210 in a square bin. In an alternative embodiment, the brine solution comprises 12.5% salt and 87.5% water (by weight). After the components of the brine solution are added to the bin, the bin is agitated for 5 minutes in order to fully dissolve the salt in the water.

Virginia peanuts are added to the bin in a 50-50 ratio of brine solution to peanuts. The peanuts are soaked 220 in the brine solution for 5-6 hours, such that they increase in weight by 25-27% and have a moisture level of 22-27%. It has been found that this soak period results in optimal levels of flavor, crunch and sodium content.

The brine solution is drained 230 from the peanuts for 1-2 hours via gravity or another suitable method. The moisture content of the drained 230 peanuts should be 21-24%. The drained 230 peanuts are oil roasted 240 at 305° F. for 11 minutes. Finally, the peanuts are stored for up to 7 days before being packaged 150 and gas flushed to prevent premature staling.

### Example Method for Spicy Brined Peanuts

A specific peanut brining method for producing spicy brined Virginia peanuts, according to one embodiment, is described below. The method for producing spicy brined Virginia peanuts is the same as the method for producing salty brined Virginia peanuts, as described in FIG. 2, with the exception of steps 210 and 220. In step 210, the brine solution is prepared 210 comprising 9.5% salt, cayenne pepper, hot sauce, and capsicum extracts in water. In step 220, the peanuts are soaked 220 in the brine solution for 6-7 hours. The resulting peanut product is spicy and salty, with a crunchy texture.

### Further Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Moreover, unless otherwise noted, percentages discussed herein are percentages by weight.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional options for drying and glazing nuts are possible. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for preparing crunchy nuts comprising:
preparing a brine solution;
soaking nuts in the brine solution;
draining the brine solution from the nuts; and
oil roasting the nuts.

2. The method of claim 1, wherein the nuts are peanuts.

3. The method of claim 2, wherein the nuts are Virginia peanuts.

4. The method of claim 1, wherein the brine solution comprises 9.5-10% salt by weight and water.

5. The method of claim 4, wherein the brine solution comprises 90% water by weight.

6. The method of claim 5, wherein said soaking has a duration of 5-6 hours.

7. The method of claim 5, wherein the brine solution comprises 9.5% salt by weight and additionally comprises one or more of cayenne pepper, hot sauce, and a capsicum extract.

8. The method of claim 7, wherein said soaking has a duration of 6-7 hours.

9. The method of claim 1, wherein said soaking has a duration of 5-16 hours.

10. The method of claim 1, wherein said soaking is continued until the nuts have 24-35% moisture content.

11. The method of claim 10, wherein said soaking is continued until the nuts have 24-26% moisture content.

12. The method of claim 1, wherein said draining continues for at least 1 hour.

13. The method of claim 12, wherein said draining continues for 1-2 hours.

14. The method of claim 1, wherein said draining continues until the nuts have 21-24% moisture content.

15. The method of claim 1, wherein the nuts are fully enrobed in oil during said oil roasting.

16. The method of claim 1, wherein said oil roasting is performed at above 300° F.

17. The method of claim 16, wherein said oil roasting is performed at approximately 305° F.

18. The method of claim 1, wherein said oil roasting is performed for at least 8 minutes.

19. The method of claim 18, wherein said oil roasting is performed for approximately 11 minutes.

20. The method of claim 1, wherein said oil roasting is performed until the nuts have less than 2% moisture content.

21. The method of claim 1, wherein said soaking is performed in a square bin.

22. The method of claim 1, wherein said soaking is performed in a partial vacuum.
